(19) United States
(12) Patent Application Publication
(10) Pub. No.: US 2025/0218082 A1
(43) Pub. Date: Jul. 3, 2025

(54) GENERATION METHOD AND APPARATUS OF BOOK INFORMATION, ELECTRONIC DEVICE, AND STORAGE MEDIUM

(71) Applicant: Beijing Zitiao Network Technology Co., Ltd., Beijing (CN)

(72) Inventors: Wenchao WANG, Beijing (CN); Xingwen ZHANG, Beijing (CN)

(21) Appl. No.: 18/949,411

(22) Filed: Nov. 15, 2024

(30) Foreign Application Priority Data
Dec. 28, 2023 (JP) 202311840951.5

(51) Int. Cl. G06T 11/60; G06F 40/109

(52) U.S. Cl. CPC G06T 11/60; G06F 40/109

(57) ABSTRACT

The present disclosure relates to a generation method and generation apparatus of book information, an electronic device, and a storage medium, and relates to the field of computer technologies. The method of the present disclosure comprises: extracting reference information in at least one dimension based on information of a book; determining a generation manner of a cover of the book based on the reference information in the at least one dimension, where generation manners corresponding to reference information in different dimensions are different; generating the cover of the book based on the generation manner, where the cover comprises a background image and excerpt information of the book; and displaying the cover of the book.

### CROSS-REFERENCE TO RELATED APPLICATIONS

This application claims the priority of Chinese Application for Invention No. 202311840951.5, filed to the Patent Office of the People's Republic of China on Dec. 28, 2023, the entire content of which is incorporated herein by reference.

### TECHNICAL FIELD

The present disclosure relates to a field of computer technologies, and in particular, to a generation method and apparatus of book information, an electronic device, and a storage medium.

### BACKGROUND

With the development of Internet technologies, electronic books are increasingly popular with users, which changes reading habits of many people.

In an electronic book application, covers of a plurality of electronic books are displayed. A cover generally comprises publication or presentation information such as a book title and an author. For some electronic books, if there are not any illustrations for the covers, the covers are displayed without comprising background images, or background images are randomly added to the covers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to some embodiments of the present disclosure, there is provided a generation of book information, comprising: extracting reference information in at least one dimension based on information of a book; determining a generation manner of a cover of the book based on the reference information in the at least one dimension, wherein generation manners corresponding to reference information in different dimensions are different; generating the cover of the book based on the generation manner, wherein the cover comprises a background image and excerpt information of the book; and displaying the cover of the book.

According to some embodiments of the present disclosure, there is provided a generation apparatus of book information, comprising: an extraction module configured to extract reference information in at least one dimension based on information of a book; a determination module configured to determine a generation manner of a cover of the book based on the reference information in the at least one dimension, wherein generation manners corresponding to reference information in different dimensions are different; a generation module configured to generate the cover of the book based on the generation manner, wherein the cover comprises a background image and excerpt information of the book; and a display module configured to display the cover of the book.

According to still some embodiments of the present disclosure, there is provided an electronic device, comprising: a memory; and a processor coupled to the memory, wherein the processor is configured to perform the generation method of book information according to any one of the embodiments of the present disclosure based on instructions stored in the memory.

According to yet some embodiments of the present disclosure, there is provided a non-transitory computer-readable storage medium having a computer program stored thereon, wherein when the program is executed by a processor, causes the processor to perform the generation method of book information according to any one of the embodiments of the present disclosure.

Other features, aspects, and advantages of the present disclosure will become apparent from the following detailed description of exemplary embodiments of the present disclosure with reference to the drawings.

### BRIEF DESCRIPTION OF THE DRAWINGS

Embodiments of the present disclosure are described below with reference to the accompanying drawings. The accompanying drawings described herein are provided to further explain the present disclosure. The accompanying drawings, together with the following detailed description, are incorporated into and form a part of this specification, and are used to explain the present disclosure. It should be understood that the accompanying drawings in the following description relate only to some embodiments of the present disclosure, rather than limiting the present disclosure. In the drawings:

FIG. 1 is a schematic flowchart of a generation method of book information according to some embodiments of the present disclosure;

FIG. 2 is a schematic diagram of a cover of a book according to some embodiments of the present disclosure;

FIG. 3 is a schematic diagram of a cover of a book according to other embodiments of the present disclosure;

FIG. 4 is a schematic diagram of a cover of a book according to still other embodiments of the present disclosure;

FIG. 5 is a schematic diagram of a cover of a book according to yet other embodiments of the present disclosure;

FIG. 6 is a schematic flowchart of the generation method of book information according to other embodiments of the present disclosure;

FIG. 7 is a schematic diagram of a details page of excerpt information according to some embodiments of the present disclosure;

FIG. 8 is a schematic diagram of a structure of a generation apparatus of book information according to some embodiments of the present disclosure;

FIG. 9 is a schematic diagram of a structure of an electronic device according to some embodiments of the present disclosure; and

FIG. 10 is a schematic diagram of a structure of the electronic device according to other embodiments of the present disclosure.

It should be understood that for the purpose of clarity, the dimensions of various parts shown in the drawings are not necessarily drawn in accordance with actual proportional relationships. The same or similar reference signs are used in the drawings to denote the same or similar parts. Therefore, once an item is defined in one drawing, it may not be further discussed in subsequent drawings.

### DETAILED DESCRIPTION

The technical solutions in the embodiments of the present disclosure are described clearly and completely below with reference to the accompanying drawings in the embodiments of the present disclosure. It is obvious that the described embodiments are some but not all of the embodiments of the present disclosure. The following description of the embodiments is actually only illustrative, and shall not be construed as limiting the present disclosure and its application or use. It should be understood that the present disclosure may be implemented in various forms and should not be construed as being limited to the embodiments set forth herein.

It should be understood that the various steps described in the method implementations of the present disclosure may be performed in different orders, and/or performed in parallel. Furthermore, additional steps may be comprised and/or the execution of the illustrated steps may be omitted in the method implementations. The scope of the present disclosure is not limited in this respect. Unless otherwise specified, the relative arrangement of components and steps, numerical expressions, and values set forth in these embodiments should be construed as merely exemplary and should not be construed as limiting the scope of the present disclosure.

The term “include/comprise” used in the present disclosure and the variations thereof are an open term that means at least the following elements/features but does not exclude other elements/features, that is, “include/comprise but not limited to”. In addition, the term “have/has” and the variations thereof used in the present disclosure are an open term that means at least the following elements/features but does not exclude other elements/features, that is, “have/has but not limited to”. Therefore, “include/comprise” and “have/has” are synonymous. The term “based on” means “at least partially based on”.

An “embodiment”, “some embodiments”, or “an embodiment” mentioned throughout the specification means that a specific feature, structure, or characteristic described in conjunction with the embodiment is comprised in at least one embodiment of the present invention. For example, the term “one embodiment” means “at least one embodiment”; the term “another embodiment” means “at least one another embodiment”; and the term “some embodiments” means “at least some embodiments”. Moreover, the appearances of the phrase “in an embodiment”, “in some embodiments”, or “in an embodiment” in various places throughout the specification are not necessarily all referring to the same embodiment, or an embodiment may be referred to.

It should be noted that concepts such as “first” and “second” mentioned in the present disclosure are only used to distinguish different apparatuses, modules, or units, and are not used to limit the sequence of functions performed by these apparatuses, modules, or units or interdependence. Unless otherwise specified, the concepts such as “first” and “second” are not intended to imply that the objects described in this way must be in a given order in time, space, ranking, or in any other way.

It should be noted that the modifiers “one” and “a plurality of” mentioned in the present disclosure are illustrative rather than restrictive, and those skilled in the art should understand that unless the context clearly indicates otherwise, it should be understood as “one or more”.

The names of messages or information exchanged between a plurality of apparatuses in the implementations of the present disclosure are used for illustrative purposes only, and are not used to limit the scope of these messages or information.

Embodiments of the present disclosure are described in detail below with reference to the accompanying drawings, but the present disclosure is not limited to these specific embodiments. These specific embodiments below can be combined with each other, and for the same or similar concepts or processes, details may not be described in some embodiments. In addition, in one or more embodiments, specific features, structures, or characteristics may be combined in any suitable manner from the present disclosure by those of ordinary skill in the art.

Currently, display effects of covers of some electronic books are not good, there are not any background images in the covers or the background images in the covers are not match content of the electronic books, only texts such as titles and authors of the electronic books are displayed in the covers, and it is difficult to effectively attract users. If a background image and a text in a cover of an electronic books are manually designed, a large amount of labor costs are required, and the efficiency is low.

To solve the above technical problems, the present disclosure provides a generation method and apparatus of book information, an electronic device, and a storage medium, which automatically generate a cover for a book, improve a matching degree between the cover and the book, and improve an display effect.

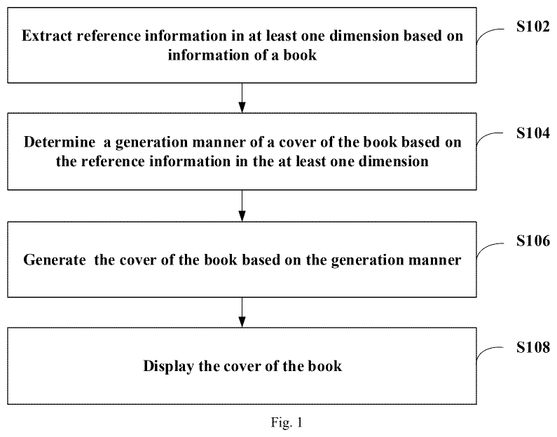

Some embodiments of the generation method of book information of the present disclosure are described below with reference to FIGS. 1 to 7.

FIG. 1 is a flowchart of some embodiments of the generation method of book information of the present disclosure. As shown in FIG. 1, the generation method of this embodiment comprises: steps S102 to S108.

In step S102, reference information in at least one dimension is extracted based on information of a book.

The book is an electronic book, and may be displayed on a client (terminal). For example, the book may be displayed on various forms of clients such as a mobile phone, a computer, and a Pad. An electronic book application (APP) may be installed on the client for displaying electronic books. For example, the information of the book comprises at least one of a name, an author, content, an illustration, classification information, excerpt information, and reading behavior information of users for the book of the book, and is not limited to the examples given.

For example, the excerpt information may be a famous saying, a classic sentence, a classic paragraph, and the like in the book. The excerpt information may be a recognized sentence by an author, a user, and the like of the book. For example, the excerpt information may be a classic sentence in some classics. The excerpt information may also be a sentence selected from the book based on the reading behavior information of the users for the book. For example, when reading the book, a user marks and comments on favorite sentences. A sentence marked (and/or commented on) most frequently in the book or a sentence marked more than a threshold number of times is determined as the excerpt information in the book, and the excerpt information is extracted from the book.

For example, the classification information of the book comprises classification information in a genre such as a novel and a prose, may also comprise classification information in a style such as a fantasy, a city, and a comedy, and may further comprise classification information in a presentation form such as a publication and a network article, and is not limited to the examples given.

The reference information in the at least one dimension comprises at least one of information about an author, the classification information, or the excerpt information. If the information of the book does not comprise the excerpt information, but only comprises the reading behavior information of the users for the book, the excerpt information may be determined based on the reading behavior information of the users for the book by using the above method.

In step S104, a generation manner of a cover of the book is determined based on the reference information in the at least one dimension, wherein generation manners corresponding to reference information in different dimensions are different.

The generation manner of the cover represents a strategy used for generating the cover, for example, how to generate a background image of the cover, which texts are comprised in the cover, a style of the texts in the cover, and the like. The reference information in different dimensions represents different focuses. For example, for books of some famous authors, generating covers based on the information about the authors are easier to attract users and highlights the characteristics of the books, so that the covers are more matched with the characteristics of the books. Therefore, different generation manners may be determined based on the reference information in different dimensions, and covers generated based on the different generation manners have different effects.

In step S106, the cover of the book is generated based on the generation manner, wherein the cover comprises a background image and excerpt information of the book.

The background image and texts may be generated based on the generation manner. The texts may comprise the excerpt information of the book, and may further comprise a name and/or an author of the book, and are not limited to the examples given. The excerpt information of the book is a most classic sentence in the book, which may reflect information such as style, type, writing style, and opinion of the author of the book, and is more likely to attract users. Adding the excerpt information of the book to the cover may improve the display effect of the cover and improve the distribution effect of the book.

In step S108, the cover of the book is displayed.

The cover of the book may be displayed in an electronic book application on the client. One or more covers of one or more books may be displayed on one page. The cover of the book may also be referred to as a card of the book, and may be displayed in a plurality of scenarios, for example, displayed on a book recommendation page, displayed on a first page or a second page of the book in response to a reading operation on the book, and the like, and is not limited to the examples given. The cover or the card of the book is used as a carrier of key information of the book, and is displayed to users to attract the users to read.

Steps related to displaying in the present disclosure may be implemented through a GUI (Graphical User Interface).

In the method of the above embodiment, the reference information in the at least one dimension is extracted based on the information of the book, the generation manner of the cover of the book is determined based on the reference information in the at least one dimension, generation manners corresponding to reference information in different dimensions are different, the cover of the book is generated based on the generation manner, and the cover of the book is displayed. The cover of the book comprises the background image and the added excerpt information. In one aspect, the display effect and the distribution effect of the book may be improved through a combination of graphic information and text information. In another aspect, the excerpt information itself may also attract users more, thereby improving the display effect and the distribution effect of the book. In the method of the above embodiment, the matched cover may be automatically generated based on the information of the book, thereby improving the efficiency of cover generation, and enabling the generated cover to be more matched with the book, thereby improving the accuracy of cover generation and the matching degree with the book. In addition, different generation manners may be used based on the reference information in different dimensions, so that the cover generation manner is more flexible, and the generated cover is more matched with the reference information in the different dimensions. The reference information in the different dimensions reflects different characteristics of the book, so that the generated cover may also reflect different characteristics of the book, thereby improving the generation effect and display effect of the cover.

In some embodiments, a generative model is used to extract the reference information in the at least one dimension based on the information of the book, the generation manner of a cover of the book is determined based on the reference information in the at least one dimension, and the cover of the book is generated based on the generation manner.

The generative model is, for example, an AIGC (Artificial Intelligence Generated Content) model. For example, the generative model may be a text-to-image model.

In some embodiments, the reference information in the at least one dimension comprises reference information in a plurality of dimensions, and the determining the generation manner of the cover of the book based on the reference information in the at least one dimension comprises: matching the reference information in the plurality of dimensions with a preset condition, to select reference information in one dimension; and determining the generation manner of the cover of the book based on the selected reference information.

In response to the reference information in the plurality of dimensions being extracted, the preset condition is used as a criterion for selecting the reference information, and the reference information in the one dimension may be selected based on the preset condition to determine the generation manner of the cover.

In some embodiments, the reference information in the at least one dimension comprises information about an author of the book, the excerpt information, and classification information of the book, and the preset condition comprises a preset type of the author and an entity for generating an image existing in the excerpt information.

Priority levels of the reference information in the plurality of dimensions may be set, and the reference information in the plurality of dimensions is sequentially matched with the preset condition based on the priority levels, to select the matched reference information in one dimension. Taking priority levels of the information about the author, the excerpt information, and the classification information from high to low as an example.

In some embodiments, the matching the reference information in the plurality of dimensions with the preset condition, to select the reference information in the one dimension comprises: matching the information about the author with the preset type, to determine whether the author belongs to the preset type; selecting the information about the author in response to the author belonging to the preset type; identifying whether there is an entity for generating an image in the excerpt information in response to the author not belonging to the preset type; selecting the excerpt information in response to the entity for generating the image existing in the excerpt information; and selecting the classification information in response to the entity for generating the image not existing in the excerpt information.

For example, the preset type is a first author type representing that the author is a famous author, or a second author type representing that the author is a published author, and the like, and is not limited to the examples given. A whitelist of the preset type may be set and stored in a database, and the information about the author of the book is matched with the information about each author in the whitelist to determine whether the author of the book belongs to the preset type.

In some embodiments, it is determined whether the book belongs to a first book type based on the classification information of the book, and in response to the book belonging to the first book type, the information about the author is matched with a preset type corresponding to the first book type to determine whether the author of the book belongs to the preset type corresponding to the first book type. For example, the first book type is a publication type, and the information about the author is matched with a whitelist of the publication type to determine whether the author belongs to the whitelist.

For example, the entity for generating the image may comprise a keyword representing at least one of landscape, person, style, and color, and is not limited to the examples given. A type of the entity for generating the image may be preconfigured. The excerpt information may be segmented, and whether the entity for generating the image exists in the excerpt information is identified.

In some embodiments, it is determined whether the book belongs to a second book type based on the classification information of the book, and in response to the book belonging to the second book type, whether the entity for generating the image exists in the excerpt information is identified. For example, the second book type is a network article type, and is not limited to the examples given.

In some embodiments, the generation manner comprises template information used for generating the cover, the template information comprises a display effect of text and a generation strategy of the background image.

In some embodiments, the generating the cover of the book based on the generation manner comprises: generating the background image in the cover based on the generation strategy of the background image; configuring a style of the text in the cover based on the display effect of the text, wherein the text comprises the excerpt information; and generating the cover of the book based on the text in the cover and the background image in the cover.

The generation strategy of the background image may comprise a model and/or information used for generating the background image. The display effect of the text may comprise display effects of different texts, for example, at least one of a display effect of the excerpt information, a display effect of a name of the book, or a display effect of the information about the author. A font, a font size, a color, and the like of the text may be configured based on the display effect of the text, and a display position of the text may also be configured. The text in the cover is synthesized with the background image in the cover to generate the cover of the book.

Some embodiments of how to generate the cover of the book based on the reference information in different dimensions is described below.

In some embodiments, the reference information in the at least one dimension comprises the excerpt information, and the generation strategy of the background image comprises: generating the background image in the cover by using a generative model based on the excerpt information.

The excerpt information may be input to the generative model to generate the background image in the cover.

In some embodiments, the generating the background image in the cover by using the generative model based on the excerpt information comprises: determining, by using the generative model, whether the excerpt information comprises an entity for generating an image; extracting the entity from the excerpt information in response to the excerpt information comprising the entity for generating the image; and generating the background image in the cover based on the entity.

For example, the entity for generating the image may comprise a keyword representing at least one of landscape, person, style, and color, and is not limited to the examples given. For example, if the excerpt information comprises “cloud”, “cloud” may be extracted, and the background image in the cover is generated by using the generative model.

In some embodiments, the reference information in the at least one dimension comprises the excerpt information, the text further comprises a name of the book, and the display effect of the text comprises displaying the name of the book in a highlighting effect.

For example, the name of the book has a larger font size and a different color than other texts. The display effect of the text may further comprise display positions of different texts. For example, the name of the book is displayed as a first line of text in the cover, or displayed in a center position, and the like, and is not limited to the examples given.

In some embodiments, the text may further comprise writings used for representing the excerpt information. For example, the writings comprise: golden sentence excerpt, classic quote, beautiful prose and excellent sentence, and the like, and is not limited to the examples given. The writings may be displayed in a highlighting effect.

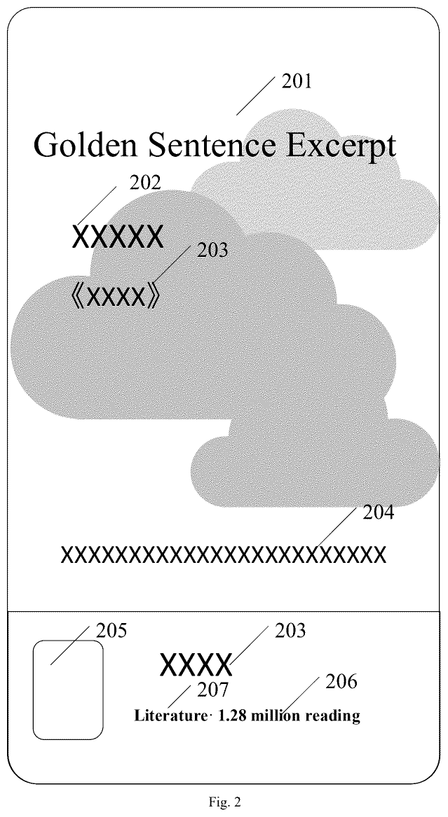

As shown in FIG. 2, the generated cover of the book comprises a background image, for example, “cloud” is extracted from the excerpt information, and the background image is generated based on “cloud”. A plurality of texts are further comprised in the cover. For example, the texts comprise writings 201 “golden sentence excerpt” used for representing the excerpt information, and “golden sentence excerpt” is displayed in a most highlighting effect. The texts further comprise a name 202 of an author, a name 203 of the book, and excerpt information 204, and positions and styles of these texts may be determined based on the display effect of the texts in the template information.

In some embodiments, the cover may further comprise an auxiliary display area of the book, and the display area may comprise at least one of a cover, the name of the book, a reading quantity of the book, classification information of the book, a comment number of the book, a collection number of the book, and a like number of the book.

As shown in FIG. 2, a cover 205, the name 203 of the book, a reading quantity 206 of the book, and classification information 207 of the book may be displayed in an auxiliary display area at a bottom of the cover. The cover in the auxiliary display area may be an original cover of the book, a cover of the book generated in a different generation manner, or the same as the current cover. For example, the current cover is generated in a generation manner corresponding to the excerpt information, and the cover in the auxiliary display area may be a cover of the book generated in a generation manner corresponding to the information about the author or the classification information of the book.

The name of the book may be displayed in the most highlighting effect in the cover of the book, which is not shown in the figure and will not be described again.

In the method of the above embodiment, the background image of the cover is generated based on the excerpt information, the style of the texts in the cover is configured based on the display effect of the texts, and the cover of the book is generated based on the texts in the cover and the background image in the cover, thereby improving the efficiency of cover generation, and enabling the generated cover to be matched with the excerpt information, thereby improving the generation effect and display effect of the cover.

In some embodiments, the reference information in the at least one dimension comprises the classification information of the book, and the generation strategy of the background image comprises: generating a plurality of candidate images corresponding to the classification information by using a generative model; and selecting one of the plurality of candidate images as the background image of the cover.

The plurality of candidate images corresponding to the classification information may be generated in advance by using the generative model, and the classification information and the plurality of candidate images are stored in a database correspondingly. In response determining that the generation manner is a generation manner corresponding to the classification information, the plurality of candidate images corresponding to the classification information are searched for in the database based on the classification information, and one of the plurality of candidate images is selected as the background image of the cover.

Different types of images may be generated in advance, and various types of classification information of the book are mapped to the different types of images to form a mapping relationship. In response to determining that the generation manner is the generation manner corresponding to the classification information, a type of an image corresponding to the classification information is determined, the plurality of candidate images of the type of the image are searched for in the database, and one of the plurality of candidate images is selected as the background image of the cover.

In some embodiments, the generating the plurality of the candidate images corresponding to the classification information by using the generative model comprises: generating the plurality of candidate images by using the generative model based on a keyword representing at least one of content, style, emotion, color, or texture corresponding to the classification information.

The generative model may be a text-to-image model, and the plurality of candidate images may be generated by using the text-to-image model based on the keyword corresponding to at least one of representation content, style, emotion, color, or texture corresponding to the classification information. For example, a keyword representing the content may be starry sky, afterglow, cloud, and the like, a keyword representing the style may be Chinese style, technology style, urban style, and the like, a keyword representing the emotion may be gloomy, cheerful, and the like, a keyword representing the color may be blackish, dark, light, warm tones, gradient, and the like, and a keyword representing the texture may be sand, wood grain, water waves, and the like.

For example, keywords corresponding to a fantasy category comprise: starry sky, halo, moon, blackish, and the like, keywords corresponding to a romance category comprise: afterglow, cloud, grass, warm tone, and cheerful, and the like, and keywords corresponding to a publication category comprise: sand, wood grain, water waves, gradient, and the like.

Various keywords representing the content, the style, the emotion, and the color may be set in advance, and the plurality of candidate images are generated based on the keywords, and then the plurality of candidate images are mapped to the classification information to obtain the plurality of candidate images corresponding to each type of classification information.

In some embodiments, the generating the plurality of candidate images corresponding to the classification information by using the generative model comprises: selecting a preset number of reference images based on the keyword representing at least one of the content, the style, the emotion, the color or the texture corresponding to the classification information, and generating the plurality of candidate images by using the generative model based on the reference images.

Reference images matched with the keyword corresponding to the classification information may be selected by using an image recognition model, and then the plurality of candidate images are generated based on the reference images. The generative model may be an image-to-image model, and the plurality of candidate images may be generated by using the image-to-image model based on the reference images.

Various keywords representing the content, the style, the emotion, the color and the texture may be set in advance, the reference images are generated based on the keywords, and then the reference images are mapped to the classification information to obtain the reference images corresponding to each type of classification information.

In some embodiments, the reference information in the at least one dimension comprises the classification information of the book, the text further comprises a name of the book, and the display effect of the text comprises displaying the name of the book in a highlighting effect.

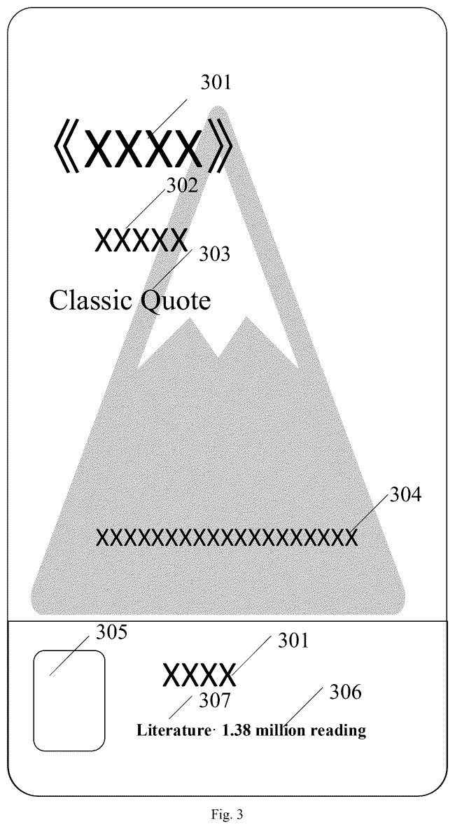

As shown in FIG. 3, the generated cover of the book comprises a background image. For example, the background image is generated based on a keyword “mountain” corresponding to the classification information of the book. A plurality of texts are further comprised in the cover. For example, the texts comprise a name 301 of the book, a name 302 of an author, and writings 303 “classic quote” used for representing the excerpt information, and the name of the book is displayed in a most highlighting effect. The texts further comprise excerpt information 305, and positions and styles of these texts may be determined based on the display effect of the texts in the template information.

As shown in FIG. 3, a cover 305, the name 303 of the book, a reading quantity 306 of the book, and classification information 307 of the book may be displayed in an auxiliary display area at the bottom of the cover. The cover in the auxiliary display area may be an original cover of the book, a cover of the book generated in a different generation manner, or the same as the current cover. For example, the current cover is generated in a generation manner corresponding to the classification information of the book, and the cover in the auxiliary display area may be a cover of the book generated in a generation manner corresponding to the information about the author or the excerpt information of the book.

In the method of the above embodiment, the background image of the cover is generated based on the classification information of the book, the style of the texts in the cover is configured based on the display effect of the texts, and the cover of the book is generated based on the texts in the cover and the background image in the cover, thereby improving the efficiency of cover generation, and enabling the generated cover to be matched with the type of the book, thereby improving the generation effect and display effect of the cover.

In some embodiments, the reference information in the at least one dimension comprises the information about the author of the book, and the generation strategy of the background image comprises: generating a plurality of images by using a generative model; and selecting one of the plurality of images as the background image of the cover.

The plurality of images may be generated in advance by using the generative model, and stored in a database. In response to determining that the generation manner is a generation manner corresponding to the information about the author, one of the plurality of images is selected as the background image of the cover in the database.

In some embodiments, the generating the plurality of images by using the generative model comprises: generating the plurality of images by using the generative model based on a keyword representing at least one of content, style, emotion, or color.

The generative model may be a text-to-image model, and the plurality of images may be generated by using the text-to-image model based on a keyword representing at least one of content, style, emotion, or color.

In some embodiments, a preset number of reference images are selected based on a keyword representing at least one of content, style, emotion, or color, and the plurality of images are generated by using the generative model based on the reference images.

Reference images matched with the keyword may be selected by using an image recognition model, and then the plurality of images are generated by using the generative model based on the reference images. The generative model may be an image-to-image model, and the plurality of images may be generated by using the image-to-image model based on the reference images.

In some embodiments, the reference information in the at least one dimension comprises the information about the author of the book, the text further comprises the information about the author, and the display effect of the text comprises that the information about the author is displayed in a highlighting effect.

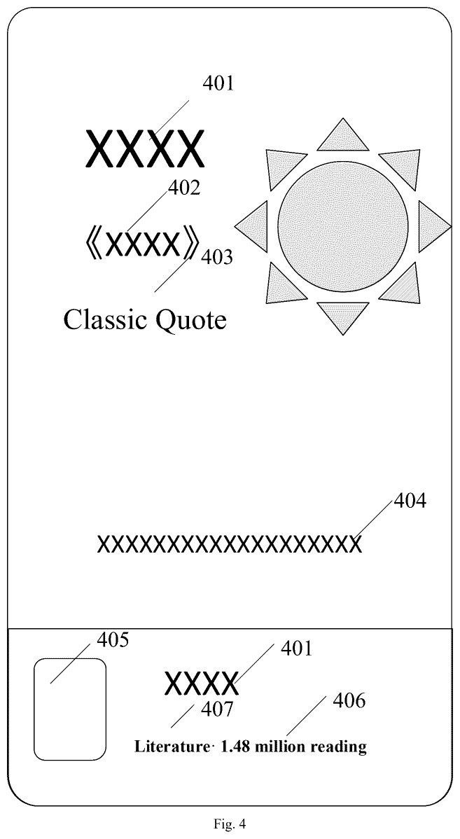

As shown in FIG. 4, the generated cover of the book comprises a background image. For example, one of the plurality of images generated by using the generative model is selected as the background image. A plurality of texts are further comprised in the cover. For example, the texts comprise a name 401 of the author, a name 402 of the book, and writings 403 “classic quote” used for representing excerpt information, and the name of the author is displayed in a most highlighting effect. The texts further comprise excerpt information 405, and positions and styles of these texts may be determined based on the display effect of the texts in the template information. Since the cover of the book is generated in a generation manner corresponding to the information about the author, the information about the author is the most important, and the information about the author is displayed in the most highlighting effect, thereby improving the display effect.

As shown in FIG. 4, a cover 405, the name 404 of the book, a reading quantity 406 of the book, and classification information 407 of the book may be displayed in an auxiliary display area at the bottom of the cover. The cover in the auxiliary display area may be an original cover of the book, a cover of the book generated in a different generation manner, or the same as the current cover. For example, the current cover is generated in a generation manner corresponding to the information about the author, and the cover in the auxiliary display area may be a cover of the book generated in a generation manner corresponding to the classification information or the excerpt information of the book.

In the method of the above embodiment, the background image of the cover is generated based on the information about the author, a style of the texts in the cover is configured based on the display effect of the texts, and the cover of the book is generated based on the texts in the cover and the background image in the cover, thereby improving the efficiency of cover generation, and enabling the generated cover to be matched with the author, thereby improving the generation effect and display effect of the cover.

In some embodiments, the generating the cover of the book based on the text in the cover and the background image in the cover further comprises: configuring at least one of transparency or a mask parameter of the background image of the cover based on the style of the text in the cover; and adding the text in the cover to the adjusted background image of the cover to generate the cover of the book.

For example, the mask parameter comprises color, brightness, contrast, saturation, and the like of a mask, and is not limited to the examples given. The mask may be understood as a layer covering the background image, and the text may be added to the mask or a layer above the mask. Automatically adapting the transparency of the background image and the mask parameter based on the style of the text may enable the background image and the text to be more matched, thereby improving the display effect.

The methods for determining the generation manner of the cover of the book based on the reference information in one dimension and generating the cover of the book based on the generation manner are described in the above embodiments. In some embodiments, the generation manner of the cover of the book is determined based on the reference information in a plurality of dimensions, and the cover of the book is generated based on the generation manner.

The reference information in the plurality of dimensions may be matched with the preset condition, to select reference information in one or more dimensions.

For example, it is determined whether the author belongs to the preset type, the information about the author is selected in response to the author belonging to the preset type. It is determined whether an entity for generating an image existing in the excerpt information, and the excerpt information is selected in response to the entity for generating the image existing in the excerpt information. The classification information of the book is most easily obtainable, and may be used as the reference information that must be selected. Alternatively, the excerpt information may be selected only in response to the entity for generating the image existing in the excerpt information, the classification information is not selected, and the classification information is selected in response to the entity for generating the image not existing in the excerpt information.

In response to selecting the information about the author and the excerpt information, the generation strategy of the background image comprises generating the background image in the cover by using the generative model based on the excerpt information, and the display effect of the text comprises displaying a name of the author in a highlighting effect. For details, reference may be made to the foregoing embodiments, and details are not described herein again.

In response to selecting the information about the author and the classification information, the generation strategy of the background image comprises generating a plurality of candidate images corresponding to the classification information by using the generative model, and selecting one of the plurality of candidate images as the background image of the cover, and the display effect of the text comprises that the name of the author is displayed in a highlighting effect. For details, reference may be made to the foregoing embodiments, and details are not described herein again.

In response to selecting the excerpt information and the classification information, the generation strategy of the background image comprises generating the background image in the cover by using the generative model based on the excerpt information and the classification information, and the display effect of the text comprises that a name of the book or writings used for representing the excerpt information is displayed in a highlighting effect.

The excerpt information and the classification information may be input to the generative model to generate the background image of the cover.

In some embodiments, the entity is extracted from the excerpt information, and the background image is generated by using the generative model based on the extracted entity and a keyword representing at least one of representation content, style, emotion, color, or texture corresponding to the classification information.

In some embodiments, the entity is extracted from the excerpt information, and a plurality of candidate images are generated by using the generative model based on a keyword representing at least one of representation content, style, emotion, color, or texture corresponding to the classification information; or a preset number of reference images are selected based on a keyword representing at least one of representation content, style, emotion, color, or texture corresponding to the classification information, and the plurality of candidate images are generated by using the generative model based on the reference images; and the plurality of candidate images are matched with the entity to obtain a candidate image comprising the entity as the background image.

In response to selecting the information about the author, the excerpt information, and the classification information, the generation strategy of the background image comprises generating the background image in the cover by using the generative model based on the excerpt information and the classification information, and the display effect of the text comprises displaying a name of the author in a highlighting effect. For the generation method of the background image, reference may be made to the foregoing embodiments, and details are not described herein again.

In some embodiments, the generated cover comprises a plurality of covers, the plurality of covers comprise different excerpt information and/or are generated in different generation manners, and the displaying the cover of the book comprises: splicing the plurality of covers; and displaying the spliced cover.

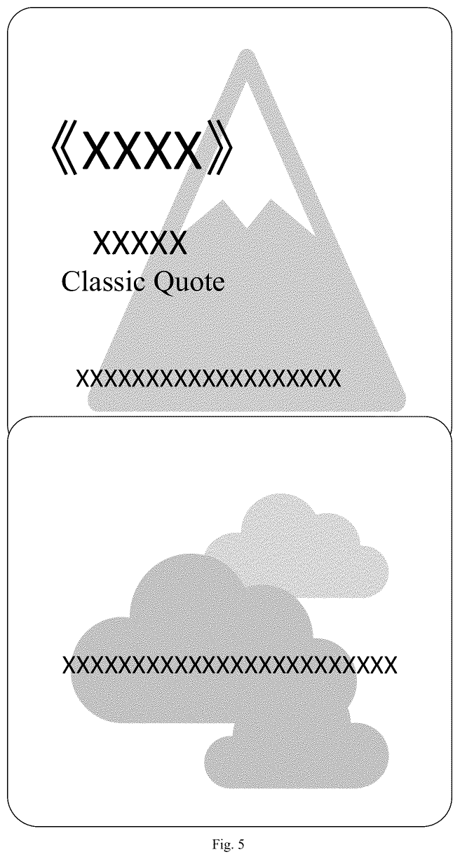

For example, background images in the plurality of covers may be generated by using different strategies. For example, one background image is generated based on the classification information, and one background image is generated based on the excerpt information. As shown in FIG. 5, two covers are spliced, the background images are different, and texts comprised may also be different.

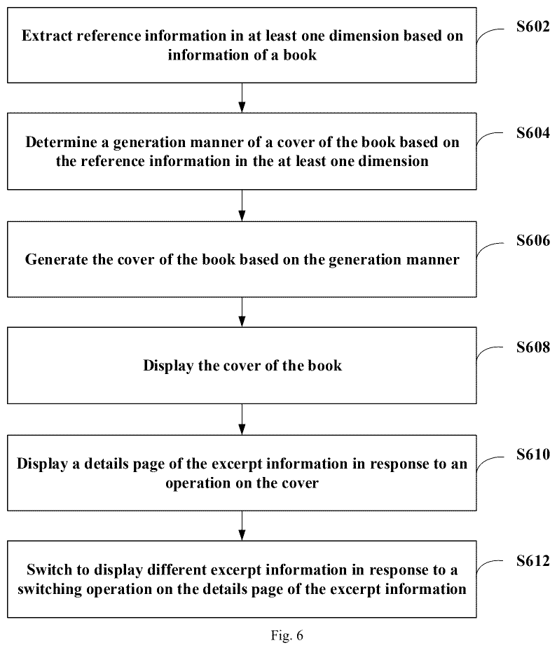

Some other embodiments of the method for generating book information of the present disclosure are described below with reference to FIG. 6.

FIG. 6 is a flowchart of some embodiments of the generation method of book information of the present disclosure. As shown in FIG. 6, the method of this embodiment comprises: steps S602 to S612.

In step S602, reference information in at least one dimension is extracted based on information of a book.

In step S604, a generation manner of a cover of the book is determined based on the reference information in the at least one dimension, wherein generation manners corresponding to reference information in different dimensions are different.

In step S606, the cover of the book is generated based on the generation manner, wherein the cover comprises a background image and excerpt information of the book.

In step S608, the cover of the book is displayed.

Covers of a plurality of books may be displayed in a form of two columns on a page such as a book recommendation page or a home page of an electronic book application, or the cover of the book may be displayed in response to an operation on the book, and is not limited to the examples given.

In step S610, a details page of the excerpt information is displayed in response to an operation on the cover.

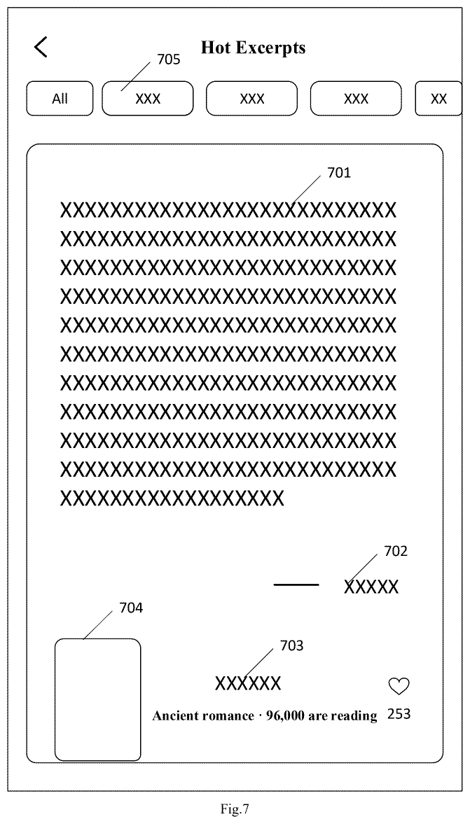

For example, as shown in FIG. 7, the details page comprises: the excerpt information 701 and a name 702 of an author. The details page may further comprise an auxiliary display area, and the auxiliary display area comprises: a name 703 of the book and a cover 704 of the book, and may further comprise at least one of classification, a reading quantity, a collection number, a like number, and a comment number of the book. The details page may further comprise an option area, and the option area comprises option controls 705 for a plurality of classifications of the book. An option control for each of the classifications corresponds to the excerpt information of the book in the each of the classifications. The excerpt information of the book in the corresponding classification is displayed in response to an operation on the option control 705 for the classification.

In step S612, different excerpt information is switched to display in response to a switching operation on the details page of the excerpt information.

For example, different excerpt information is displayed in a switched manner in response to a sliding operation in a preset direction on the details page of the excerpt information. For example, the excerpt information of a next book is displayed in response to sliding to the left, and the excerpt information of a previous book is displayed in response to sliding to the right. In response to switching to the excerpt information of a last book in a classification, the excerpt information of a book in a next classification is displayed in response to a backward switching operation on the details page of the excerpt information. In response to switching to the excerpt information of a first book in a classification, the excerpt information of a book in a previous classification is displayed in response to a forward switching operation on the details page of the excerpt information.

In the method of the above embodiment, the cover of the book is automatically generated and displayed, thereby improving the display effect and the distribution effect of the book, and improving the efficiency, accuracy, and matching degree with the book of cover generation.

The present disclosure further provides a generation apparatus of book information, which is described below with reference to FIG. 8.

FIG. 8 is a block diagram of some embodiments of the generation apparatus of book information of the present disclosure. As shown in FIG. 8, the generation apparatus 80 of this embodiment comprises: an extraction module 810, a determination module 820, a generation module 830, and a display module 840.

The extraction module 810 is configured to extract reference information in at least one dimension based on information of a book.

The determination module 820 is configured to determine a generation manner of a cover of the book based on the reference information in the at least one dimension, wherein generation manners corresponding to reference information in different dimensions are different.

The generation module 830 is configured to generate the cover of the book based on the generation manner, wherein the cover comprises a background image and excerpt information of the book.

The display module 840 is configured to display the cover of the book.

In some embodiments, the generation manner comprises template information used for generating the cover, the template information comprises a display effect of text and a generation strategy of the background image, and the generation module 830 is configured to generate the background image in the cover based on the generation strategy of the background image; configure a style of the text in the cover based on the display effect of the text, wherein the text comprises the excerpt information; and generate the cover of the book based on the text in the cover and the background image in the cover.

In some embodiments, the reference information in the at least one dimension comprises the excerpt information, and the generation module 830 is configured to generate the background image in the cover by using a generative model based on the excerpt information.

In some embodiments, the generation module 830 is configured to determine, by using the generative model, whether the excerpt information comprises an entity for generating an image; extract the entity from the excerpt information in response to the excerpt information comprising the entity for generating the image; and generate the background image in the cover based on the entity.

In some embodiments, the reference information in the at least one dimension comprises the excerpt information, the text further comprises a name of the book, and the display effect of the text comprises displaying the name of the book in a highlighting effect.

In some embodiments, the reference information in the at least one dimension comprises classification information of the book, and the generation module 830 is configured to generate a plurality of candidate images corresponding to the classification information by using a generative model; and select one of the plurality of candidate images as the background image of the cover.

In some embodiments, the generation module 830 is configured to generate the plurality of candidate images by using the generative model based on a keyword corresponding to at least one of content, style, emotion, color, or texture corresponding to the classification information; or select a preset number of reference images based on a keyword corresponding to at least one of the content, the style, the emotion, the color or the texture corresponding to the classification information, and generate the plurality of candidate images by using the generative model based on the reference images.

In some embodiments, the reference information in the at least one dimension comprises classification information of the book, the text further comprises a name of the book, and the display effect of the text comprises displaying the name of the book in a highlighting effect.

In some embodiments, the reference information in the at least one dimension comprises information about an author of the book, and the generation module 830 is configured to generate a plurality of images by using a generative model; and select one of the plurality of images as the background image of the cover.

In some embodiments, the generation module 830 is configured to generate the plurality of images by using the generative model based on a keyword representing at least one of content, style, emotion, or color; or select a preset number of reference images based on a keyword representing at least one of the content, the style, the emotion, or the color, and generate the plurality of images by using the generative model based on the reference images.

In some embodiments, the reference information in the at least one dimension comprises the information about the author of the book, the text further comprises the information about the author, and the display effect of the text comprises displaying the information about the author in a highlighting effect.

In some embodiments, the reference information in the at least one dimension comprises reference information in a plurality of dimensions, and the determination module 820 is configured to match the reference information in the plurality of dimensions with a preset condition, to select reference information in one dimension; and determine the generation manner of the cover of the book based on the selected reference information.

In some embodiments, the reference information in the at least one dimension comprises information about an author of the book, the excerpt information, and classification information of the book, and the preset condition comprises a preset type of the author and an entity for generating an image in the excerpt information, and the determination module 820 is configured to match the information about the author with the preset type, to determine whether the author belongs to the preset type; select the information about the author when the author belongs to the preset type; identify whether there is an entity for generating an image in the excerpt information in response to the author not belonging to the preset type; select the excerpt information in response to the entity for generating the image existing in the excerpt information; and select the classification information in response to the entity for generating the image not existing in the excerpt information.

In some embodiments, the generation module 830 is configured to configure at least one of transparency or a mask parameter of the background image of the cover based on the style of the text in the cover; and add the text in the cover to the adjusted background image of the cover to generate the cover of the book.

In some embodiments, the cover comprises a plurality of covers, the plurality of covers comprise different excerpt information, and/or the plurality of covers are generated in different generation manners, and the display module 840 is configured to splice the plurality of covers; and display the spliced cover.

In some embodiments, the display module 840 is further configured to display a details page of the excerpt information in response to an operation on the cover.

In some embodiments, the display module 840 is further configured to switch to display different excerpt information in response to a switching operation on the details page of the excerpt information.

It should be noted that the above units (modules) are only logical modules divided according to specific functions implemented by the units (modules), and are not used to limit specific implementation methods. For example, the units (modules) may be implemented in a manner of software, hardware, or a combination of software and hardware. In actual implementation, the above units may be implemented as independent physical entities, or may be implemented by a single entity (for example, a processor (such as a CPU or DSP), an integrated circuit, etc.). In addition, the above units are shown in dashed lines in the figures, indicating that these units may not actually exist, and the operations/functions implemented by them may be implemented by the processing circuit itself.

In addition, although not shown, the apparatus may further comprise a memory that may store various information generated by the apparatus and each unit comprised in the apparatus during an operation, a program and data for the operation, data to be sent by a communication unit, and the like. The memory may be a volatile memory and/or a non-volatile memory. For example, the memory may comprise but is not limited to a random access memory (RAM), a dynamic random access memory (DRAM), a static random access memory (SRAM), a read-only memory (ROM), a flash memory, and the like. Certainly, the memory may also be located outside the apparatus. Alternatively, although not shown, the apparatus may further comprise a communication unit that may be configured to communicate with another apparatus. In an example, the communication unit may be implemented in an appropriate manner known in the art, for example, the communication unit comprises communication components such as an antenna array and/or a radio frequency link, various types of interfaces, a communication unit, and the like. Details are not described herein. In addition, the apparatus may further comprise other components not shown, such as a radio frequency link, a baseband processing unit, a network interface, a processor, a controller, and the like. Details are not described herein.

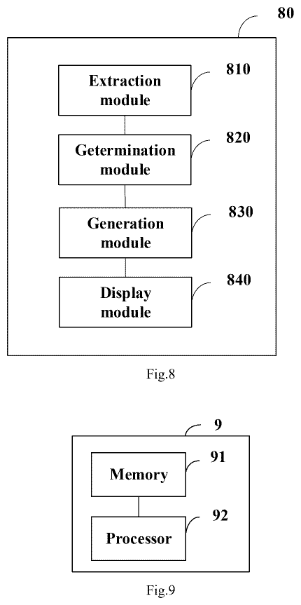

Some embodiments of the present disclosure further provide an electronic device. FIG. 9 is a block diagram of some embodiments of an electronic device of the present disclosure. For example, in some embodiments, the electronic device 9 may be various types of devices, for example, may comprise but is not limited to mobile terminals such as a mobile phone, a notebook computer, a digital broadcast receiver, a PDA (personal digital assistant), a PAD (tablet computer), a PMP (portable multimedia player), and a vehicle-mounted terminal (such as a vehicle navigation terminal), and fixed terminals such as a digital TV and a desktop computer. For example, the electronic device 9 may comprise a display panel for displaying data and/or an execution result used in the solution of the present disclosure. For example, the display panel may have various shapes, for example, a rectangular panel, an oval panel, or a polygonal panel. In addition, the display panel may be not only a flat panel, but also a curved panel or even a spherical panel.

As shown in FIG. 9, the electronic device 9 of this embodiment comprises: a memory 91 and a processor 92 coupled to the memory 91. It should be noted that the components of the electronic device 90 shown in FIG. 9 are merely exemplary and not restrictive, and the electronic device 90 may further have other components depending on an actual application requirement. The processor 92 may control other components in the electronic device 9 to perform a desired function.

In some embodiments, the memory 91 is configured to store one or more computer-readable instructions. The processor 92 is configured to run the computer-readable instructions, and when the computer-readable instructions are run by the processor 92, the method according to any one of the foregoing embodiments is implemented. For the specific implementation and related explanation of each step of the method, reference may be made to the foregoing embodiments, and details of the same parts will not be repeated here.

For example, the processor 92 and the memory 91 may directly or indirectly communicate with each other. For example, the processor 92 and the memory 91 may communicate through a network. The network may comprise a wireless network, a wired network, and/or any combination of a wireless network and a wired network. The processor 92 and the memory 91 may also communicate with each other through a system bus, which is not limited in the present disclosure.

For example, the processor 92 may be implemented as various appropriate processors, processing units, etc., such as a central processing unit (CPU), a graphics processing unit (GPU), a network processor (NP), etc.; it may also be a digital signal processor (DSP), an application-specific integrated circuit (ASIC), a field programmable gate array (FPGA) or other programmable logic devices, a discrete gate or transistor logic device, or a discrete hardware component. The central processing unit (CPU) may have an X86 or ARM architecture, etc. For example, the memory 91 may comprise any combination of various forms of computer-readable storage media, for example, a volatile memory and/or a non-volatile memory. For example, the memory 91 may comprise a system memory, for example, the system memory stores an operating system, an application program, a boot loader, a database, and other programs. Various application programs and various data are also stored in the storage medium.

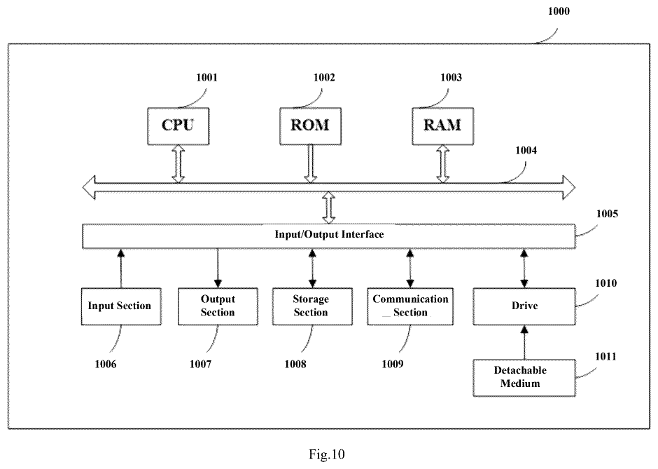

In addition, according to some embodiments of the present disclosure, when various operations/processes according to the present disclosure are implemented by software and/or firmware, a program constituting the software may be installed from a storage medium or a network into a computer system with a specific hardware structure, for example, the computer system (or electronic device) 1000 shown in FIG. 10, and the computer system, when various programs are installed, can perform various functions, comprising functions such as the foregoing functions, and the like. FIG. 10 is a block diagram showing an example structure of a computer system that can be adopted in the embodiments of the present disclosure.

In FIG. 10, a central processing unit (CPU) 1001 performs various processes in accordance with a program stored in a read-only memory (ROM) 1002 or a program loaded from a storage section 1008 into a random access memory (RAM) 1003. In the RAM 1003, data required when the CPU 1001 performs various processes and the like is also stored as required. The central processing unit is merely an example, and it may also be other types of processors, such as the various processors described above. The ROM 1002, the RAM 1003, and the storage section 1008 may be various forms of computer-readable storage media, as described below. It should be noted that although the ROM 1002, the RAM 1003, and the storage section 1008 are shown separately in FIG. 10, one or more of them may be combined or located in the same or different memory or storage module.

The CPU 1001, the ROM 1002, and the RAM 1003 are connected to each other through a bus 1004. An input/output interface 1005 is also connected to the bus 1004.

The following components are connected to the input/output interface 1005: an input section 1006 comprising a touch screen, a touchpad, a keyboard, a mouse, an image sensor, a microphone, an accelerometer, a gyroscope, and the like; an output section 1007 comprising a display such as a cathode ray tube (CRT) and a liquid crystal display (LCD), a speaker, and a vibrator; a storage section 1008 comprising a hard disk, a tape, and the like; and a communication section 1009 comprising a network interface card such as a LAN card and a modem. The communication section 1009 allows communication processing to be performed via a network such as the Internet. It is readily understood that although not shown in FIG. 10, the apparatuses or modules in the computer system (or electronic device) 1000 may also communicate with each other through a network or other means, where the network may comprise a wireless network, a wired network, and/or any combination of a wireless network and a wired network.

A drive 1010 is also connected to the input/output interface 1005 as required. A detachable medium 1011 such as a magnetic disk, an optical disk, a magneto-optical disk, a semiconductor memory, and the like is installed on the drive 1010 as required, so that a computer program read therefrom is installed into the storage section 1008 as required.

When the above series of processing is performed by software, the program constituting the software may be installed from a network such as the Internet or a storage medium such as the detachable medium 1011.

According to the embodiments of the present disclosure, the processes described above with reference to the flowcharts may be implemented as computer software programs. For example, this embodiment of the present disclosure comprises a computer program product, which comprises a computer program carried on a computer readable medium, where the computer program comprises program code for performing the method shown in the flowchart. In such an embodiment, the computer program may be downloaded from a network through the communication section 1009 and installed, installed from the storage section 1008, or installed from the ROM 1002. When the computer program is executed by the CPU 1001, the above functions defined in the method of the embodiments of the present disclosure are executed.

It should be noted that in the context of the present disclosure, a computer-readable medium may be a tangible medium that may contain or store a program for use by or in combination with an instruction execution system, apparatus, or device. The computer-readable medium may be a computer-readable signal medium, a computer-readable storage medium, or any combination thereof. Examples of the computer-readable storage medium may comprise, but are not limited to: electrical, magnetic, optical, electromagnetic, infrared, or semiconductor systems, apparatuses, or devices, or any combination thereof. A more specific example of the computer-readable storage medium may comprise, but is not limited to: an electrical connection having one or more wires, a portable computer magnetic disk, a hard disk, a random access memory (RAM), a read-only memory (ROM), an erasable programmable read-only memory (EPROM or a flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may comprise a data signal propagated in a baseband or as a part of a carrier, the data signal carrying computer-readable program code. The propagated data signal may be in various forms, comprising but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, comprising but not limited to: electric wires, optical cables, radio frequency (RF), and the like, or any suitable combination thereof.

The above computer-readable medium may be contained in the above electronic device; or may exist independently without being assembled into the electronic device.

In some embodiments, a computer program is further provided, and the computer program comprises instructions that, when executed by a processor, cause the processor to perform the method according to any one of the foregoing embodiments. For example, the instructions may be embodied as computer program code.

In the embodiments of the present disclosure, the computer program code for performing the operations of the present disclosure may be written in one or more programming languages or a combination thereof, where the programming languages comprise but are not limited to an object-oriented programming language, such as Java, Smalltalk, and C++, and further comprise conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user through any type of network (comprising a local area network (LAN) or a wide area network (WAN)), or may be connected to an external computer (for example, connected through the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules, components, or units described in the embodiments of the present disclosure may be implemented by means of software, or may be implemented by means of hardware. The names of the modules, components, or units do not constitute a limitation on the modules, components, or units in some cases.

The functions described herein above may be performed at least partially by one or more hardware logic components. For example, exemplary hardware logic components that may be used without limitation comprise: a field programmable gate array (FPGA), an application-specific integrated circuit (ASIC), an application-specific standard product (ASSP), a system on chip (SOC), a complex programmable logic device (CPLD), and the like.

According to some embodiments of the present disclosure, there is provided a generation method of book information, comprising: extracting reference information in at least one dimension based on information of a book; determining a generation manner of a cover of the book based on the reference information in the at least one dimension, wherein generation manners corresponding to reference information in different dimensions are different; generating the cover of the book based on the generation manner, wherein the cover comprises a background image and excerpt information of the book; and displaying the cover of the book.

In some embodiments, the generation manner comprises template information used for generating the cover, the template information comprises a display effect of text and a generation strategy of the background image, and the generating the cover of the book based on the generation manner comprises: generating the background image in the cover based on the generation strategy of the background image; configuring a style of the text in the cover based on the display effect of the text, wherein the text comprises the excerpt information; and generating the cover of the book based on the text in the cover and the background image in the cover.

In some embodiments, the reference information in the at least one dimension comprises the excerpt information, and the generation strategy of the background image comprises: generating the background image in the cover by using a generative model based on the excerpt information.

In some embodiments, the generating the background image in the cover by using the generative model based on the excerpt information comprises: determining, by using the generative model, whether the excerpt information comprises an entity for generating an image; extracting the entity from the excerpt information in response to the excerpt information comprising the entity for generating the image; and generating the background image in the cover based on the entity.

In some embodiments, the reference information in the at least one dimension comprises the excerpt information, the text further comprises a name of the book, and the display effect of the text comprises displaying the name of the book in a highlighting effect.

In some embodiments, the reference information in the at least one dimension comprises classification information of the book, and the generation strategy of the background image comprises: generating a plurality of candidate images corresponding to the classification information by using a generative model; and selecting one of the plurality of candidate images as the background image of the cover.

In some embodiments, the generating the plurality of candidate images corresponding to the classification information by using the generative model comprises: generating the plurality of candidate images by using the generative model based on a keyword representing at least one of content, style, emotion, color, or texture corresponding to the classification information; or selecting a preset number of reference images based on the keyword representing at least one of the content, the style, the emotion, the color or the texture corresponding to the classification information, and generating the plurality of candidate images by using the generative model based on the reference images.

In some embodiments, the reference information in the at least one dimension comprises classification information of the book, the text further comprises a name of the book, and the display effect of the text comprises displaying the name of the book in a highlighting effect.

In some embodiments, the reference information in the at least one dimension comprises information about an author of the book, and the generation strategy of the background image comprises: generating a plurality of images by using a generative model; and selecting one of the plurality of images as the background image of the cover.

In some embodiments, the generating the plurality of images by using the generative model comprises: generating the plurality of images by using the generative model based on a keyword representing at least one of content, style, emotion, or color; or selecting a preset number of reference images based on the keyword representing at least one of the content, the style, the emotion, or the color, and generating the plurality of images by using the generative model based on the reference images.

In some embodiments, the reference information in the at least one dimension comprises information about an author of the book, the text further comprises the information about the author, and the display effect of the text comprises displaying the information about the author in a highlighting effect.

In some embodiments, the reference information in the at least one dimension comprises reference information in a plurality of dimensions, and the determining the generation manner of the cover of the book based on the reference information in the at least one dimension comprises: matching the reference information in the plurality of dimensions with a preset condition, to select reference information in one dimension; and determining the generation manner of the cover of the book based on the selected reference information.

In some embodiments, the reference information in the at least one dimension comprises information about an author of the book, the excerpt information, and classification information of the book, the preset condition comprises a preset type of an author and an entity for generating an image existing in the excerpt information, and the matching the reference information in the plurality of dimensions with the preset condition, to select the reference information in the one dimension comprises: matching the information about the author with the preset type, to determine whether the author belongs to the preset type; selecting the information about the author in response to the author belonging to the preset type; identifying whether there is an entity for generating an image in the excerpt information in response to the author not belonging to the preset type; selecting the excerpt information in response to the entity for generating the image existing in the excerpt information; and selecting the classification information in response to the entity for generating the image not existing in the excerpt information.

In some embodiments, the generating the cover of the book based on the text in the cover and the background image in the cover further comprises: configuring at least one of transparency or a mask parameter of the background image of the cover based on the style of the text in the cover; and adding the text in the cover to the adjusted background image of the cover, to generate the cover of the book.

In some embodiments, the cover comprises a plurality of covers, the plurality of covers comprise different excerpt information and/or are generated in different generation manners, and the displaying the cover of the book comprises: splicing the plurality of covers; and displaying a spliced cover.

In some embodiments, the generation method further comprises: displaying a details page of the excerpt information in response to an operation on the cover.

In some embodiments, the generation method further comprises: switching to display different excerpt information in response to a switching operation on the details page of the excerpt information.

According to some other embodiments of the present disclosure, there is provided a generation apparatus of book information, comprising: an extraction module, configured to extract reference information in at least one dimension based on information of a book; a determination module, configured to determine a generation manner of a cover of the book based on the reference information in the at least one dimension, wherein generation manners corresponding to reference information in different dimensions are different; a generation module, configured to generate the cover of the book based on the generation manner, wherein the cover comprises a background image and excerpt information of the book; and a display module, configured to display the cover of the book.

According to some further embodiments of the present disclosure, there is provided an electronic device, comprising: a memory; and a processor coupled to the memory, where the processor is configured to execute the generation method of book information according to any one of the embodiments of the present disclosure based on instructions stored in the memory.

According to some further embodiments of the present disclosure, there is provided a computer-readable storage medium having stored thereon a computer program that, when executed by a processor, implements the generation method of book information according to any one of the embodiments of the present disclosure.

According to some further embodiments of the present disclosure, there is provided a computer program, comprising instructions that, when executed by a processor, cause the processor to perform the generation method of book information according to any one of the embodiments of the present disclosure.

According to some embodiments of the present disclosure, there is provided a computer program product, comprising instructions that, when executed by a processor, implement the generation method of book information according to any one of the embodiments of the present disclosure.

The above descriptions are merely some embodiments of the present disclosure and explanations of the applied technical principles. A person skilled in the art should understand that the scope of disclosure involved in the present disclosure is not limited to the technical solutions formed by a specific combination of the foregoing technical features, and shall also cover other technical solutions formed by any combination of the foregoing technical features or equivalent features thereof without departing from the above disclosure concept. For example, a technical solution formed by replacing the foregoing features with technical features with similar functions disclosed in the present disclosure (but not limited thereto).

In the descriptions provided herein, a number of specific details are set forth. However, it is understood that embodiments of the present disclosure may be implemented without these specific details. In some other instances, well-known methods, structures and technologies are not shown in detail so as not to blur understanding of the description.

Furthermore, although the operations are depicted in a specific order, it should not be understood as requiring these operations to be performed in the specific order shown or in a sequential order. Under specific circumstances, multitasking and parallel processing may be advantageous. Similarly, although several specific implementation details are comprised in the foregoing discussions, these details should not be construed as limiting the scope of the present disclosure. Some features that are described in the context of separate embodiments may alternatively be implemented in combination in a single embodiment. In contrast, various features described in a single embodiment may alternatively be implemented in a plurality of embodiments individually or in any suitable sub-combination.

Although some specific embodiments of the present disclosure are described in detail through examples, a person skilled in the art should understand that the above examples are merely for illustration, rather than limiting the scope of the present disclosure. A person skilled in the art should understand that the above embodiments may be modified without departing from the scope and spirit of the present disclosure. The scope of the present disclosure is defined by the appended claims.

What is claimed is:

1. A generation method of book information, comprising:
extracting reference information in at least one dimension based on information of a book;
determining a generation manner of a cover of the book based on the reference information in the at least one dimension, wherein generation manners corresponding to reference information in different dimensions are different;
generating the cover of the book based on the generation manner, wherein the cover comprises a background image and excerpt information of the book; and
displaying the cover of the book.

2. The generation method according to claim 1, wherein the generation manner comprises template information used for generating the cover, the template information comprises a display effect of text and a generation strategy of the background image, and the generating the cover of the book based on the generation manner comprises:
generating the background image in the cover based on the generation strategy of the background image;
configuring a style of the text in the cover based on the display effect of the text, wherein the text comprises the excerpt information; and
generating the cover of the book based on the text in the cover and the background image in the cover.

3. The generation method according to claim 2, wherein the reference information in the at least one dimension comprises the excerpt information, and the generation strategy of the background image comprises:
generating the background image in the cover by using a generative model based on the excerpt information.

4. The generation method according to claim 3, wherein the generating the background image in the cover by using the generative model based on the excerpt information comprises:
determining, by using the generative model, whether the excerpt information comprises an entity for generating an image;
extracting the entity from the excerpt information in response to the excerpt information comprising the entity for generating the image; and
generating the background image in the cover based on the entity.

5. The generation method according to claim 2, wherein the reference information in the at least one dimension comprises the excerpt information, the text further comprises a name of the book, and the display effect of the text comprises displaying the name of the book in a highlighting effect.

6. The generation method according to claim 2, wherein the reference information in the at least one dimension comprises classification information of the book, and the generation strategy of the background image comprises:
generating a plurality of candidate images corresponding to the classification information by using a generative model; and
selecting one of the plurality of candidate images as the background image of the cover.

7. The generation method according to claim 6, wherein the generating the plurality of candidate images corresponding to the classification information by using the generative model comprises:
generating the plurality of candidate images by using the generative model based on a keyword representing at least one of content, style, emotion, color, or texture corresponding to the classification information; or
selecting a preset number of reference images based on the keyword representing at least one of the content, the style, the emotion, the color or the texture corresponding to the classification information, and generating the plurality of candidate images by using the generative model based on the reference images.

8. The generation method according to claim 2, wherein the reference information in the at least one dimension comprises classification information of the book, the text further comprises a name of the book, and the display effect of the text comprises displaying the name of the book in a highlighting effect.

9. The generation method according to claim 2, wherein the reference information in the at least one dimension comprises information about an author of the book, and the generation strategy of the background image comprises:
generating a plurality of images by using a generative model; and
selecting one of the plurality of images as the background image of the cover.

10. The generation method according to claim 9, wherein the generating the plurality of images by using the generative model comprises:
generating the plurality of images by using the generative model based on a keyword representing at least one of content, style, emotion, or color; or
selecting a preset number of reference images based on the keyword representing at least one of the content, the style, the emotion, or the color, and generating the plurality of images by using the generative model based on the reference images.

11. The generation method according to claim 2, wherein the reference information in the at least one dimension comprises information about an author of the book, the text further comprises the information about the author, and the display effect of the text comprises displaying the information about the author in a highlighting effect.

12. The generation method according to claim 1, wherein the reference information in the at least one dimension comprises reference information in a plurality of dimensions, and the determining the generation manner of the cover of the book based on the reference information in the at least one dimension comprises:
matching the reference information in the plurality of dimensions with a preset condition, to select reference information in one dimension; and
determining the generation manner of the cover of the book based on the selected reference information.

13. The generation method according to claim 12, wherein the reference information in the at least one dimension comprises information about an author of the book, the excerpt information, and classification information of the book, the preset condition comprises a preset type of an author and an entity for generating an image existing in the excerpt information, and the matching the reference information in the plurality of dimensions with the preset condition, to select the reference information in the one dimension comprises:
matching the information about the author with the preset type, to determine whether the author belongs to the preset type;
selecting the information about the author in response to the author belonging to the preset type;
identifying whether there is an entity for generating an image in the excerpt information in response to the author not belonging to the preset type;
selecting the excerpt information in response to the entity for generating the image existing in the excerpt information; and
selecting the classification information in response to the entity for generating the image not existing in the excerpt information.

14. The generation method according to claim 2, wherein the generating the cover of the book based on the text in the cover and the background image in the cover further comprises:
configuring at least one of transparency or a mask parameter of the background image of the cover based on the style of the text in the cover; and
adding the text in the cover to the adjusted background image of the cover, to generate the cover of the book.

15. The generation method according to claim 1, wherein the cover comprises a plurality of covers, the plurality of covers comprise different excerpt information and/or are generated in different generation manners, and the displaying the cover of the book comprises:
splicing the plurality of covers; and
displaying a spliced cover.

16. The generation method according to any one of claim 1, further comprising:
displaying a details page of the excerpt information in response to an operation on the cover.

17. The generation method according to claim 16, further comprising:
switching to display different excerpt information in response to a switching operation on the details page of the excerpt information.

18. An electronic device, comprising:
a processor; and
a memory coupled to the processor and configured to store instructions, wherein the instructions, when executed by the processor, cause the processor to:
extract reference information in at least one dimension based on information of a book;
determine a generation manner of a cover of the book based on the reference information in the at least one dimension, wherein generation manners corresponding to reference information in different dimensions are different;
generate the cover of the book based on the generation manner, wherein the cover comprises a background image and excerpt information of the book; and
display the cover of the book.

19. A non-transitory computer-readable storage medium having a computer program stored thereon, wherein when the program is executed by a processor, causes the processor to implement:
extract reference information in at least one dimension based on information of a book;
determine a generation manner of a cover of the book based on the reference information in the at least one dimension, wherein generation manners corresponding to reference information in different dimensions are different;
generate the cover of the book based on the generation manner, wherein the cover comprises a background image and excerpt information of the book; and
display the cover of the book.

20. The electronic device according to claim 19, wherein the generation manner comprises template information used for generating the cover, the template information comprises a display effect of text and a generation strategy of the background image, and the generating the cover of the book based on the generation manner comprises:
generating the background image in the cover based on the generation strategy of the background image;
configuring a style of the text in the cover based on the display effect of the text, wherein the text comprises the excerpt information; and
generating the cover of the book based on the text in the cover and the background image in the cover.
